(19) United States
(12) Patent Application Publication
(10) Pub. No.: US 2008/0106248 A1
(43) Pub. Date: May 8, 2008

(54) Voltage Regulator Configured to Exchange Commands and Data with a Power Management Engine

(75) Inventors: Jaber Abu Qahouq, Beaverton, OR (US); Lilly Huang, Portland, OR (US); Wayne Proefrock, Hillsboro, OR (US); Paul Diefenbaugh, Portland, OR (US)

Correspondence Address: GROSSMAN, TUCKER, PERREAULT & PFLEGER, PLLC;C/O PORTFOLIO IP, P. O. BOX 52050, MINNEAPOLIS, MN, 55402, US

(73) Assignee: INTEL CORPORATION, Santa Clara, CA (US)

(21) Appl. No.: 11/556,785

(22) Filed: Nov. 6, 2006

(51) Int. Cl. G05F 1/10; H02J 1/00

(52) U.S. Cl. 323/318

(57) ABSTRACT

The present disclosure provides voltage regulator configured to exchange commands and data with a power management engine. A method according to one embodiment may include generating, by a voltage regulator, at least one state signal indicative of the operational parameters of the voltage regulator; transmitting, by the voltage regulator, the at least one state signal to a power management engine; generating, by the power management engine, at least one power management signal based on, at least in part, the at least one state signal; transmitting, by the power management engine, the at least one power management signal to the voltage regulator; and controlling the operation of the voltage regulator based on, at least in part, the at least one power management signal. Of course, many alternatives, variations and modifications are possible without departing from this embodiment.

### FIELD

The present disclosure relates to a voltage regulator configured to exchange commands and data with a power management engine.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one exemplary system embodiment in accordance with the present disclosure; and

FIG. 2 is a flowchart illustrating operations according to one embodiment in accordance with the present disclosure.

Although the following Detailed Description will proceed with reference being made to illustrative embodiments, many alternatives, modifications, and variations thereof will be apparent to those skilled in the art.

### DETAILED DESCRIPTION

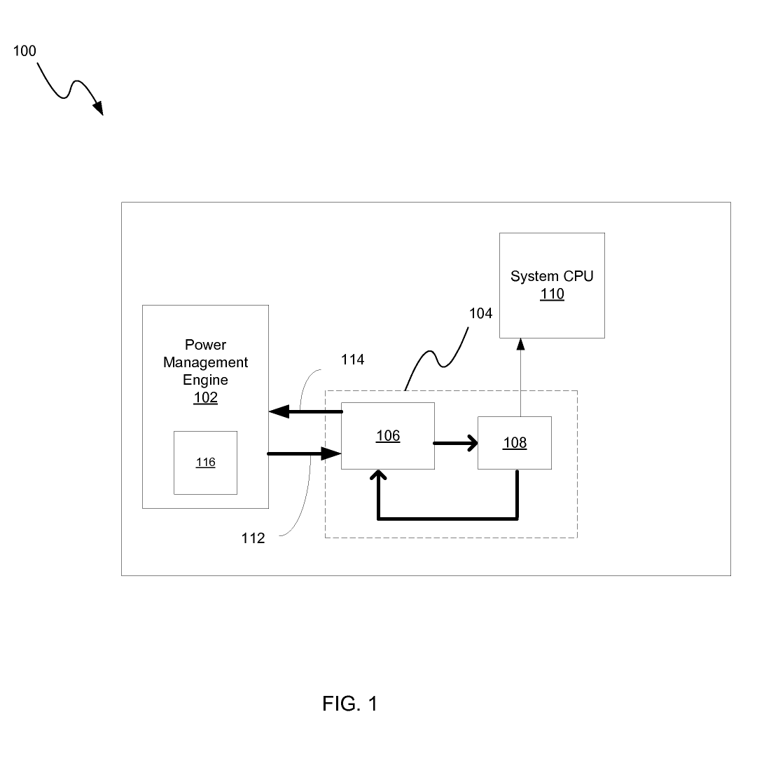

FIG. 1 illustrates one exemplary system embodiment 100. The system 100 may include a platform that includes platform power management engine circuitry 102 (“power management engine”) and voltage regulator circuitry 104 (“voltage regulator”). It should be understood that voltage regulator 104 may include any power converter and/or inverter topology, and thus, should be broadly construed as any power processing circuitry. Voltage regulator 104 may generally include power delivery circuitry to deliver power to a load, for example, system CPU 110. As will be described in greater detail below, the voltage regulator 104 may be configured to exchange commands and data with the power management engine 102. This may enable, for example, the voltage regulator 104 to adjust and reconfigure control parameters such as switching frequency, synchronous rectifier (SR) dead time, control mode, drive voltage and compensation constants based on input received from the power management engine 102, rather than passively reacting to load demands. Moreover, the voltage regulator has a bidirectional communication with the power management engine and other regulators in the power delivery such that the voltage regulator affects the power management and system operations and request certain power levels and/or timing sequences. In this embodiment, voltage regulator 104 may include a control circuitry 106 and power converter circuitry 108, such as a DC to DC converter.

It will be understood by those skilled in the art that power converter circuitry 108 may include any variety of DC to DC converter topologies. For example, power converter circuitry 108 may comprise, for example, a Buck converter, a boost converter and/or a Buck/boost converter. Thus, although not shown in the drawings, each of these topologies represent well-known DC- to DC converters. As is well-known in the art, a Buck converter may include a switch that is controlled by a pulse width modulation (PWM) signal to control the amount of power delivered to a reactive network (e.g., inductor/capacitor combination) and ultimately, to control the amount of power delivered to a load. The Buck converter typically operates as a step-down converter to convert one DC voltage level to another DC voltage level (for example, 5V to 3.3V). The amount of power delivered to the load depends upon, at least in part, the duty cycle of the PWM signal. In one exemplary embodiment herein, control circuitry 106 may be configured to control the duty cycle of a PWM signal to control the amount of power delivered by the power converter 108. A boost converter is a similar well-known converter topology and may be used, for example, as a step-up converter. A Buck-boost converter is yet another well known converter topology.

As is also well-known, a Buck, boost and/or Buck-boost converter may operate in a continuous conduction mode (CCM) in which the current in an inductor remains positive. Alternatively or additionally, a Buck, boost and/or Buck-boost converter may operate in a discontinuous conduction mode (DCM) in which the current in an inductor falls to zero (or approximately zero) for a duration of time. Continuous conduction mode may be selected when the amount of power delivered to a load is relatively large, and discontinuous conduction mode may be selected when the amount of power delivered to a load is relatively small. In at least one embodiment, controller 106 may be configured to control converter 108 to operate in a continuous and/or discontinuous conduction mode, depending on, for example, the amount of power delivered to a load. Of course, it should be recognized that the present disclosure may utilize other and/or after-developed power converter topologies without departing from this embodiment.

The controller 106 may be configured generate at least one state signal and transmit the at least one state signal to the power management engine 102, via link 114. A “state signal” as used herein with reference to controller 106, may be defined as signal indicative of at least one operational parameter of the voltage regulator 104. Exemplary state signals include, for example, the maximum power that can be delivered by the voltage regulator (Pmax_delivered), a state transition signal indicative of a successful transition to a target power state (Pst_good), a state transition signal indicative of a failure to transition to a target power state (Pst_no), a voltage rail status signal (Vstatus), and a signal indicative of a maximum latency to transition between power states (Ttrans). Of course, these are only examples of state information that may be generated by the controller 106. In addition, controller 106 may be configured operate in a variety of power management states. For example, controller 106 may be configured to receive power state information from a variety of sources in the platform 100.

Power management engine 102 may be configured to manage power of one or more devices of the platform 100 based on, for example, predefined power management routines. For example, power management engine 102 may be configured to provide power management consistent with power states defined in the Advanced Configuration and Power Interface (ACPI) specification, version 3.0, Sep. 2, 2004, published by the assignee of the subject application in conjunction with Hewlett-Packard® Corporation, Microsoft® Corporation, Phoenix Technologies® Ltd., and Toshiba® Corporation. These states may include, for example, S0, S1, etc., and/or C0, C1, etc., and/or D0, D1, etc., as may be defined under the ACPI standard. Alternatively or additionally, engine 102 may be configured to manage power consistent fine-grain power management (FGPM) methodologies, which may provide more precise control over power levels inside the system 100. These states may include, for example, S0i2 (Sleep Valley, Siesta Mode) defined under the FGPM standard. For example, FGPM may be used to put individual functions of a given system to sleep while they are idle, resulting in greater power savings. In addition to predefined power states, power management engine 102 may be configured to provide specific power management control information based on the state signals provided by the controller 106.

Power management engine 102 may be configured to generate one or more power management signals and transmit one or more power management signals to the controller 106, via link 112. The power management signals may be based on predefined power management routines that may include, for example, the aforementioned ACPI power management states. In addition, the power management engine 102 of this embodiment may generate at least one power management signal, based on, at least in part, the state signals generated by controller 106. To that end, the power management engine may include a state table 116 that includes one or more operational parameters of the voltage regulator 104. The state table may be generated, for example, based on the state signals provided by the voltage regulator 104. The state table 116 may provide the power management engine 102 with “knowledge” of the capabilities and/or operational characteristics of the voltage regulator. And thus, the power management engine 102 may generate at least one power management signal to control the operation of the voltage regulator based on, at least in part, the information provided in the state table 116. The state table 116 may be populated with data that includes one or more state parameters (generated by the voltage regulator 104), as described above. State table 116 may reside within the power management engine 102, within the voltage regulator 104 and/or in memory (not shown) external to both power management engine 102 and voltage regulator 104.

Exemplary power management signals may include, for example, a signal indicative of a desired wake up voltage when said voltage regulator is placed in a power delivery state from a powered-down state (Wake_Up), a signal indicative of maximum power to be delivered by the voltage regulator in the next power state (Pstate_max), a signal indicative of the minimum power to be delivered by the voltage regulator in the next power state (Pstate_min), and the minimum duration that the voltage regulator is to reside in the next power state (Tstate_min). Of course, these are provided only as examples of power management signals. In at least one embodiment, the power management signals may comply or be compatible with the aforementioned ACPI standard so that, for example, the power delivered by the voltage regular complies with this standard.

In operation, controller 106 may be configured to control the operation of the power converter 108 based on, at least in part, power management signals received from the power management engine 102. For example, when voltage regulator 104 is in a start up mode, the power management engine 102 may generate a Pstate_max signal and transit this signal to controller 106. This signal may indicate the desired power to be delivered by the voltage regulator 104. For example, if Pstate_max=10 W, a predefined code, such as 00 through 11 may indicate a power range from 0 W to 10 W.

Tables 1 and 2 below depict exemplary power management signals, generated by the power management engine 102, to control the operation of the voltage regulator 104. In these Tables, power management engine 102 may generate signals indicative of the maximum (PSTATE_MAX) and minimum (PSTATE_MIN) power for the next power state of the voltage regulator 104. In addition, the power management engine 102 may specify other operational parameters such as the switching frequency (fs) of the switch of the power converter 108 (this may correspond to the duty cycle of the PWM signal, as described above), whether to operate in CCM or DCM mode, the dead time for each power state, and voltage references that may be used for load line voltage adjustment.

TABLE 1

| | | | | | Voltage |
|---|---|---|---|---|---|
| | | Switching | | | Reference for |
| | | frequency | | Dead | Load line |
| PSTATE_MAX | PSTATE_MIN | (fs) | Operation Mode | Time | adjustment |
| 01 (25%) | 00 (0%) | 100 kHz | DCM | 10 ns | 1 V + 10 mV |
| 10 (50%) | 01 (25%) | 200 kHz | DCM | 20 ns | 1 V + 0 mV |
| 11 (100%) | 10 (50%) | 500 kHz | CCM | 40 ns | 1 V − 10 mV |

TABLE 2

| | | Switching frequency | Operation | |
|---|---|---|---|---|
| PSTATE_MAX | PSTATE_MIN | (fs) | Mode | Dead Time |
| 01 (25%) | 00 (0%) | 50 kHz < fs < 100 kHz | DCM | 0 ns < td < 10 ns |
| 10 (50%) | 01 (25%) | 100 kHz < fs < 200 kHz | DCM | 10 ns < td < 30 ns |
| 11 (100%) | 10 (50%) | 300 kHz < fs < 400 kHz | CCM | 20 ns < td < 50 ns |

The controller 106 may utilize the information shown in Tables 1 and 2 in a variety of different ways. For example, the voltage regulator operational characteristics (parameters) may be specified as absolute values (e.g., fs=100 kHz) based on the power management interface signals as shown in Table 1. Alternatively or additionally, the parameters may be specified as a range of values, such as the switching frequency and dead time ranges depicted in Table 2. These ranges may be used to set the internal boundaries of other operational parameters of the controller 106 (e.g., using an adaptive tracking algorithm).

Based on the communication between a power management engine and the voltage regulator, the power stage may be dynamically reprogrammed (reconfigured) with new set of design parameters to optimize operation of the power stage. Table 1 and Table 2 are examples of such parameters which can be reprogrammed into the power stage and its controller.

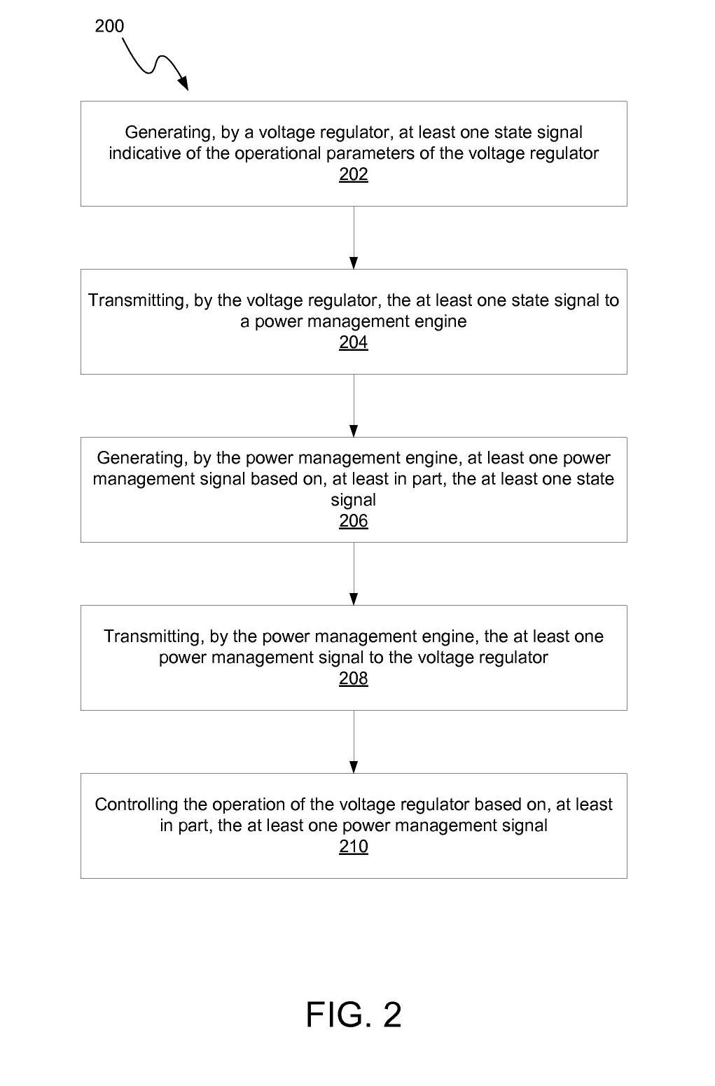

FIG. 2 is a flowchart illustrating one method consistent with one embodiment of the present disclosure. The method of this embodiment may include generating, by a voltage regulator, at least one state signal indicative of the operational parameters of the voltage regulator 202. Operations may further include transmitting, by the voltage regulator, the at least one state signal to a power management engine 204. Operations may also include generating, by the power management engine, at least one power management signal based on, at least in part, the at least one state signal 206. Operations may additionally include transmitting, by the power management engine, the at least one power management signal to the voltage regulator 208 and controlling the operation of the voltage regulator based on, at least in part, the at least one power management signal 210.

The exchange of commands and/or data between the power management engine 102 and the controller 106 may be implemented using a variety of communication protocols. For example, communication may include a predefined digital code having a certain number of bits, and transmitted between the power management engine 102 and the controller 106 using serial and/or parallel communication. In other embodiments, commands and data may be exchanged between the power management engine 102 and the controller 106 using, for example, multilevel analog signals.

The information transmitted from power management engine 102 may include system and/or specific load (or IC) power management data. More specifically, the power management engine 102 may generate power management signals indicative of a desired power state, power level, and/or timing data. This information may be directly or indirectly used by controller 106 to optimize efficiency, convergence boundary and control stability. For example, controller 106 may use a signal (e.g., TSTATE) to determine if it should enter a new adaptive state and adjust the parameters of the converter 108, or stay in the current state.

The parameters of the power converter 108 may be controlled to switch between power delivery states by modified one or more parameters of the power converter Some of the parameters may include, but are not limited to, switching frequency, synchronous rectification (SR) dead time, control mode, drive voltage and compensation constants. Some embodiments may provide a method for readjusting these control parameters or power stages according to the dynamic behaviors of the load-under-demand. For example, if the load demand changes from I1 to I2, the voltage regulator parameters may change from a switching frequency of 500 kHz and a synchronous rectification (SR) dead time of 50 ns to a switching frequency of 300 kHz and a corresponding SR dead time of 35 ns. This adaptive control method may provide optimal efficiency and performance during power conversion by utilizing a predictive control method to determine the optimal operation parameters.

Embodiments of the methods described above may be implemented in a computer program that may be stored on a storage medium having instructions to program a system (e.g., a machine) to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

Some of the embodiments described herein may be used in conjunction with a variety of different platforms including, but not limited to, personal computers, mobile and/or handheld devices, cellphones, personal digital assistants, ultra mobile personal computers or any other devices powered by a battery or any energy limited source. The methods described herein may be applied to any computing or communication system having a voltage regulator or power converter. Further, the term “voltage regulator”, as used herein is intended to broadly cover any power delivery device. “Circuitry”, as used in any embodiment herein, may comprise, for example, singly or in any combination, hardwired circuitry, programmable circuitry, state machine circuitry, and/or firmware that stores instructions executed by programmable circuitry. It should be understood at the outset that any of the operative components described in any embodiment herein may also be implemented in software, firmware, hardwired circuitry and/or any combination thereof.

The present disclosure may provide numerous advantages. For example, exchanging commands and data between the voltage regulator 104 and the power management engine 104 may enable increased accuracy and control over the power delivery of the voltage regulator 104. In addition, although the embodiment of FIG. 1 depicts a single voltage regulator 104 in communication with power management engine 102, it should be understood that alternative embodiments may include multiple voltage regulators. In such an embodiment, power management engine 102 may be configured to exchange commands and data with a plurality of voltage regulators, for example, to control the operation of each voltage regulator by exchanging state information and power management information, as described above.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A voltage regulator, comprising:
a controller and a power converter, the controller is configured to exchange commands and data with a power management engine, said controller is further configured to generate and transmit at least one state signal to a power management engine and receive at least one power management signal from the power management engine, said controller is further configured and to control the amount of power delivered by the power converter based on, at least in part, the at least one power management signal received from the power management engine.

2. The voltage regulator of claim 1, wherein
said at least one state signal comprises a signal indicative of an operational parameter of said power converter.

3. The voltage regulator of claim 2, wherein
said power management signal is based on, at least in part, said at least one state signal.

4. The voltage regulator of claim 1, wherein
the power converter is a DC to DC converter.

5. The voltage regulator of claim 1, wherein
said at least one state signal is selected from at least one of the group comprising a signal indicative of the maximum power that can be delivered by the voltage regulator, a state transition signal indicative of a successful transition to a target power state, a state transition signal indicative of a failure to transition to a target power state, a voltage rail status signal, and a signal indicative of a maximum latency to transition between power states.

6. The voltage regulator of claim 1, wherein
said at least one power management signal is selected from at least one of the group comprising a signal indicative of a desired wake up voltage when said voltage regulator is placed in a power delivery state from a powered-down state, a signal indicative of maximum power to be delivered by the voltage regulator in the next power state, a signal indicative of the minimum power to be delivered by the voltage regulator in the next power state, and the minimum duration that the voltage regulator is to reside in the next power state.

7. The voltage regulator of claim 1, wherein
said controller is further configured to transition from a first power state to a second power state based on, at least in part, at least one power management signal received from said power management engine.

8. A system, comprising:
voltage regulator comprising a controller and a power converter, said controller is further configured to generate and transmit at least one state signal, and
a power management engine configured to generate at least one power management signal;
said controller and said power management engine are further configured to exchange commands and data with each other, said controller is further configured to transmit said at least one state signal to a power management engine and receive said at least one power management signal from the power management engine, said controller is further configured and to control the amount of power delivered by the power converter based on, at least in part, the at least one power management signal received from the power management engine.

9. The system of claim 8, wherein
said at least one state signal comprises a signal indicative of an operational parameter of said power converter.

10. The system of claim 8, wherein
said power management signal is based on, at least in part, said at least one state signal.

11. The system of claim 8, wherein
the power converter is a DC to DC converter.

12. The system of claim 8, wherein
said at least one state signal is selected from at least one of the group comprising a signal indicative of the maximum power that can be delivered by the voltage regulator, a state transition signal indicative of a successful transition to a target power state, a state transition signal indicative of a failure to transition to a target power state, a voltage rail status signal, and a signal indicative of a maximum latency to transition between power states.

13. The system of claim 8, wherein
said at least one power management signal is selected from at least one of the group comprising a signal indicative of a desired wake up voltage when said voltage regulator is placed in a power delivery state from a powered-down state, a signal indicative of maximum power to be delivered by the voltage regulator in the next power state, a signal indicative of the minimum power to be delivered by the voltage regulator in the next power state, and the minimum duration that the voltage regulator is to reside in the next power state.

14. The system of claim 8, wherein
said controller is further configured to transition from a first power state to a second power state based on, at least in part, at least one power management signal received from said power management engine.

15. An article, comprising:
a storage medium storing instructions that when executed by a machine result in the following operations:
generating, by a voltage regulator, at least one state signal indicative of the operational parameters of the voltage regulator;
transmitting, by the voltage regulator, the at least one state signal to a power management engine;
generating, by the power management engine, at least one power management signal based on, at least in part, the at least one state signal;
transmitting, by the power management engine, the at least one power management signal to the voltage regulator; and
controlling the operation of the voltage regulator based on, at least in part, the at least one power management signal.

16. The article of claim 15, wherein:
said at least one state signal is selected from at least one of the group comprising a signal indicative of the maximum power that can be delivered by the voltage regulator, a state transition signal indicative of a successful transition to a target power state, a state transition signal indicative of a failure to transition to a target power state, a voltage rail status signal, and a signal indicative of a maximum latency to transition between power states.

17. The article of claim 15, wherein
said at least one power management signal is selected from at least one of the group comprising a signal indicative of a desired wake up voltage when said voltage regulator is placed in a power delivery state from a powered-down state, a signal indicative of maximum power to be delivered by the voltage regulator in the next power state, a signal indicative of the minimum power to be delivered by the voltage regulator in the next power state, and the minimum duration that the voltage regulator is to reside in the next power state.

18. The article of claim 15, further comprising:
transitioning, by said voltage regulator, from a first power state to a second power state based on, at least in part, at least one power management signal received from said power management engine.

19. A method, comprising:
generating, by a voltage regulator, at least one state signal indicative of the operational parameters of the voltage regulator;
transmitting, by the voltage regulator, the at least one state signal to a power management engine;
generating, by the power management engine, at least one power management signal based on, at least in part, the at least one state signal;
transmitting, by the power management engine, the at least one power management signal to the voltage regulator; and
controlling the operation of the voltage regulator based on, at least in part, the at least one power management signal.

20. The method of claim 19, wherein:
said at least one state signal is selected from at least one of the group comprising a signal indicative of the maximum power that can be delivered by the voltage regulator, a state transition signal indicative of a successful transition to a target power state, a state transition signal indicative of a failure to transition to a target power state, a voltage rail status signal, and a signal indicative of a maximum latency to transition between power states.

21. The method of claim 19, wherein
said at least one power management signal is selected from at least one of the group comprising a signal indicative of a desired wake up voltage when said voltage regulator is placed in a power delivery state from a powered-down state, a signal indicative of maximum power to be delivered by the voltage regulator in the next power state, a signal indicative of the minimum power to be delivered by the voltage regulator in the next power state, and the minimum duration that the voltage regulator is to reside in the next power state.

22. The method of claim 19, further comprising:
transitioning, by said voltage regulator, from a first power state to a second power state based on, at least in part, at least one power management signal received from said power management engine.

23. The voltage regulator of claim 1, wherein:
said power management engine is configured to control said voltage regulator to reconfigure the operational characteristics of said voltage regulator.

24. The system of claim 8, wherein:
said power management engine is configured to control said voltage regulator to reconfigure the operational characteristics of said voltage regulator.

25. The article of claim 15, further comprising:
Reconfiguring, by said voltage regulator, one or more operational characteristics of said voltage regulator based on, at least in part, said at least on state signal.

26. The method of claim 19, further comprising:
Reconfiguring, by said voltage regulator, one or more operational characteristics of said voltage regulator based on, at least in part, said at least on state signal.
